(19) United States
(12) Patent Application Publication
(10) Pub. No.: US 2022/0247007 A1
(43) Pub. Date: Aug. 4, 2022

(54) BATTERY MODULE HOUSING AND ARRANGEMENT OF BATTERY MODULES

(71) Applicant: Lisa Dräxlmaier GmbH, Vilsbiburg (DE)

(72) Inventors: Alexander HAHN, Roettenbach (DE); Michael STECKEL, Vilsbiburg (DE); Peter FALTERMEIER, Landshut (DE); Stefan SEIDL, Landshut (DE)

(21) Appl. No.: 17/590,831

(22) Filed: Feb. 2, 2022

(30) Foreign Application Priority Data
Feb. 2, 2021 (DE) 10 2021 102 360

(51) Int. Cl. H01M 10/6556; H01M 50/204; H01M 10/613

(52) U.S. Cl. CPC H01M 10/6556; H01M 10/613; H01M 50/204

(57) ABSTRACT

A battery module housing is set out having a housing inner space which is arranged to receive at least one battery cell. The module housing includes a housing inner wall which spatially separates the housing inner space from a housing outer wall of the battery module housing. The housing inner wall includes at least one opening which is arranged to allow a cooling fluid to flow from the cooling fluid distributor into the housing inner space.

### CROSS REFERENCE TO RELATED APPLICATIONS

This application claims priority to German Patent Application DE102021102360.2, filed Feb. 2, 2021, the content of which is herein incorporated by reference.

### BACKGROUND OF THE INVENTION

### Field of the Invention

The present invention relates to a battery module housing. Furthermore, the invention relates to an arrangement of battery modules.

### Description of Related Art

Electrically powered vehicles are driven by electric motors. The energy required to drive the electric motor is taken from a battery. Battery cells are inserted in the battery. When energy is drawn from the battery, electrical resistance, and associated power losses, such as internal resistance of the battery cell or contact resistance, result in power loss which is converted into heat. This power dissipation leads to permanent and full-scale heating of all battery cells in the battery. Without heat dissipation, the battery cells overheat, and this can lead to the destruction of a battery cell or even the entire battery. For this reason, the battery cells must be cooled. It is also important that the temperature distribution within the battery is very uniform and that there are no so-called hotspots, i.e., local elevated temperatures at some battery cells, which would accelerate the aging process of these battery cells.

German patent application DE102015108426 B4 describes a device for the cooling of at least one single cell battery, comprising an actively cooled first cooling plate, wherein the first cooling plate is connected to the at least one single cell in a thermal contact, a second cooling plate designed as a heat conducting plate, which is in thermal contact with the at least one single cell. Furthermore, the device comprises at least one heat pipe, wherein the first cooling plate is thermally connected to the second cooling plate via the at least one heat pipe, so that the heat generated by the at least one single cell can be dissipated to the first cooling plate and the second cooling plate, wherein the first cooling plate is arranged above the second cooling plate and the at least one heat pipe is arranged substantially perpendicular to the first cooling plate in the operating state.

### BRIEF SUMMARY OF THE INVENTION

One task of the invention is therefore to provide simple cooling of battery cells using means that are as simple as possible in terms of design.

This and other tasks are solved by the objects of the independent claims. Advantageous further embodiments of the invention are indicated in the dependent claims, the description and the accompanying figures.

One aspect of the invention relates to a battery module housing comprising a housing inner space, which is arranged to receive at least one battery cell, a housing inner wall, which spatially separates the housing inner space from a housing outer wall of the battery module housing, wherein a cooling fluid distributor is formed between the housing inner wall and the housing outer wall, and the housing inner wall comprises at least one opening configured to allow a cooling fluid to flow from the cooling fluid distributor into the housing inner space. The battery module housing can accommodate a battery cell, for example a round cell, in the housing interior. The battery module housing includes a housing inner wall and a housing outer wall. The housing inner wall faces the housing outer wall. The housing inner wall spatially separates the housing inner space from the housing outer wall.

The battery cell may be held by a battery cell holder in the battery module housing. A plurality of battery cells may be received in the housing interior of the battery module housing. The battery cells may be arranged in the housing interior in a plurality of rows. The rows may be staggered so that the cooling fluid can flow between the battery cells. It is desirable to minimize the volume of the housing interior containing the battery cells so that little cooling fluid is required. For example, the battery cells can be arranged at a very small distance from each other in the housing interior. The cooling fluid flows between the housing inner wall and the housing outer wall. The battery cells may be electrically connected in parallel. The battery module housing can be manufactured in one piece via injection molding, so that the battery module housing is fluid-tight. This allows good sealing against the cooling fluid to be produced. In addition, no additional components, such as screws, are required.

In one embodiment, the inner wall of the housing includes a plurality of openings, which are distributed in the inner wall of the housing.

The number of openings per inner wall of the housing can vary. The cooling fluid from the cooling fluid distributor enters the interior of the housing via the openings, which allows the battery cells to be cooled.

In another embodiment, a cross-section of the cooling fluid manifold is at least as large as a sum of all cross-sections of the plurality of openings.

In a further embodiment, the cross-section of the cooling fluid distributor is √2 larger than the sum of all cross-sections of the plurality of openings. This allows the cooling fluid to flow into the interior of the housing in an evenly distributed manner.

In a further embodiment, the openings are formed in the inner wall of the housing in such a way as to arranged in such a way that when the cooling fluid flows into the interior of the housing, the cooling fluid flows around a battery module element. The battery module element can be for example a battery cell or a battery cell holder. The position of the openings on the inner wall of the housing should be selected in such a way that the battery module element generates a flow resistance of the cooling fluid. The flow of the cooling fluid is inhibited by the battery module element and flows around the battery module element. This allows a uniform flow of the cooling fluid around the interior of the housing and thus uniform cooling of the battery cells.

In yet another embodiment, the interior of the housing includes a plurality of arranged battery cells and at least one opening is provided for at least one battery cell associated with the housing. The openings can be arranged on the inner wall of the housing in such a way that a cooling fluid quantity of the cooling fluid is led evenly up to each battery cell. The cooling fluid thus flows around each individual cooling element in the housing interior. The number of openings may vary depending on the number of battery cells.

In a further embodiment, the respective one opening is located immediately in front of one of the openings closest to the battery cell. The distance between the battery cell and the opening should be selected to be as low as possible. The cooling fluid can thus quickly reach the battery cell. The battery cell is cooled directly by the cooling fluid which thus flows around and absorbs the heat from the battery cell so that the battery cell is cooled.

In another embodiment, the cooling fluid manifold includes a cooling fluid inlet, which is arranged to allow the cooling fluid to flow into the cooling fluid distributor. The cooling fluid inlet may be a cooling fluid reservoir which is connected via connecting lines and/or hoses to the cooling fluid manifold. The cooling fluid inlet may include a pump which pumps the cooling fluid into the cooling fluid distributor.

In another embodiment, the battery module housing includes a further inner wall of the housing and between the further inner wall of the housing and a further housing outer wall another cooling fluid manifold may be formed. The further inner wall of the housing comprises at least one further opening, which is arranged to allow the cooling fluid to flow out of the interior of the housing. For example, the further cooling fluid distributor can be arranged opposite the cooling fluid distributor. The cooling fluid may flow into the interior of the housing via the at least one opening from the cooling fluid manifold. The cooling fluid may flow around the battery cells. As the cooling fluid flows around the battery cells, the cooling fluid heats up as it absorbs excess heat from the battery cells. The heated cooling fluid can flow out of the interior of the housing into the further cooling fluid distributor via the further openings.

In another embodiment, the further cooling fluid manifold comprises a cooling fluid outlet, which is arranged to discharge the cooling fluid from the further cooling fluid distributor to flow out. The heated cooling fluid can flow out of the cooling fluid outlet from the further cooling fluid distributor. An electrically non-conductive cooling fluid, for example transformer oil, may be used for the cooling fluid.

Another aspect of the invention relates to an array of battery modules having a first battery module housing comprising a housing inner space in which at least one battery cell is accommodated, a housing inner wall which spatially separates the housing inner space from a housing outer wall of the battery module housing, wherein a cooling fluid distributor is formed between the housing inner wall and the housing outer wall, and the housing inner wall comprises at least one opening which is arranged to allow a cooling fluid to flow into the housing inner space from the cooling fluid distributor. Furthermore, the arrangement comprises a further battery module housing having a housing inner space in which at least one battery cell is accommodated, a housing inner wall spatially separating the housing inner space from a housing outer wall of the battery module housing, wherein a cooling fluid distributor is formed between the housing inner wall and the housing outer wall, and the housing inner wall comprises at least one opening which is arranged to allow a cooling fluid to flow from the cooling fluid distributor into the housing interior, wherein the cooling fluid distributor of the first battery module housing is connected to the cooling fluid distributor of the second battery module housing and the cross-section of the cooling fluid distributor of the first battery module housing is larger than the cross-section of the cooling fluid distributor of the second battery module housing.

In order for a uniform flow of the cooling fluid to take place within the battery modules, the cross-section of the cooling fluid manifold of the first battery module housing must be larger than the cross-section of the cooling fluid manifold of the second battery module housing. The uniform supply of cooling fluid to each battery cell results in uniform cooling of the battery cell of the first battery module housing and the battery cell of the second battery module housing. It is thus achieved that only the battery cells have a temperature difference, but not the battery modules to each other.

In another embodiment, the assembly may include a plurality of battery module enclosures.

For example, the battery cells of the battery modules may be held by a battery cell holder in the battery module housing. The battery cell holder may be made of a foamed material. For example, the battery cell holder may be made of a foam material. For each battery cell, the battery cell holder includes a recess into which the battery cell is inserted and fixed in the battery cell holder. For example, round cells may be used as battery cells. The end faces of the round cells can be exposed from the battery cell holder. The round cells are inserted in the battery module housing in such a way that the cooling fluid can flow directly around the end faces. The cooling fluid is displaced by the battery cell holder so that the cooling fluid only flows around the end faces. Other types of battery cells can also be arranged in the battery module housings.

The arrangement of battery modules can be interconnected to form a vehicle battery of an electrically powered vehicle. An electrically powered vehicle is understood to include a hybrid vehicle or a purely electric vehicle.

In one embodiment, the cooling fluid manifold of the first battery module housing comprises a cooling fluid inlet, which is arranged to feed the cooling fluid into the cooling fluid manifold of the first battery module housing. Since the cooling fluid manifold of the first battery module housing is connected to the cooling fluid manifold of the second battery module housing, the cooling fluid flowing in through the cooling fluid inlet flows not only through the cooling fluid manifold of the first battery module housing but also through the cooling fluid manifold of the second battery module housing. Thus, simultaneous cooling of the battery cells of the first battery module housing and the second battery module housing can be achieved. The second battery module housing may include a cooling fluid drain, which is arranged to drain the cooling fluid from the cooling fluid manifold of the second battery module housing to flow out.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, with departing from the scope of the disclosure.

Advantageous embodiments of the invention are explained below with reference to the accompanying figures, wherein:

FIG. 1 depicts a schematic sectional view of a battery module according to an example embodiment of the present invention; and

FIG. 2 depicts a schematic representation of a plurality of battery modules according to a further embodiment of the present invention.

### DETAILED DESCRIPTION OF THE INVENTION

As used throughout the present disclosure, unless specifically stated otherwise, the term “or” encompasses all possible combinations, except where unfeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

The figures are merely schematic representations and serve only to explain the invention. Identical or similarly acting elements are marked throughout with the same reference signs.

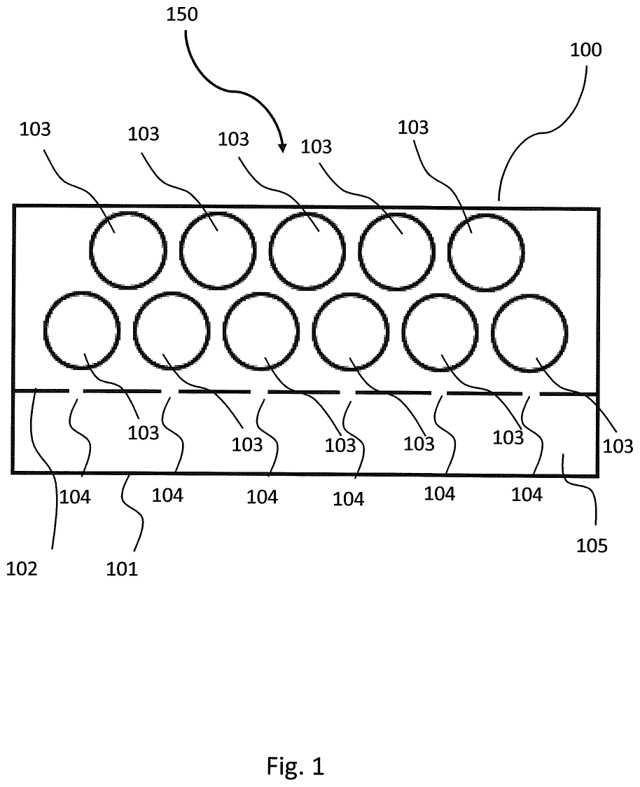

FIG. 1 depicts a battery module 150 having a battery module housing 100. The battery module housing 100 includes a housing outer wall 101 and a housing inner wall 102. The battery module housing 100 may be integrally formed using injection molding techniques. A plurality of battery cells 103 are disposed in the battery module 150. The battery cells 103 are arranged in rows. The rows are arranged in a staggered manner with respect to each other. The inner wall of the housing 102 includes a plurality of openings 104, each of the openings 104 being associated with a battery cell 103. The openings 104 are spaced a small distance from the battery cells 103. A cooling fluid manifold 105 is formed between the housing inner wall 102 and the housing outer wall 101. A cooling fluid flows into the battery module housing 100 via the cooling fluid manifold 105. Via the openings 104, the cooling fluid enters a housing interior in which the battery cells 103 are arranged. As the cooling fluid flows around the battery cells, the battery cells are directly cooled, and the cooling fluid absorbs heat from the battery cells and is conducted away from the battery cells so that an appropriately required cooling capacity can be achieved.

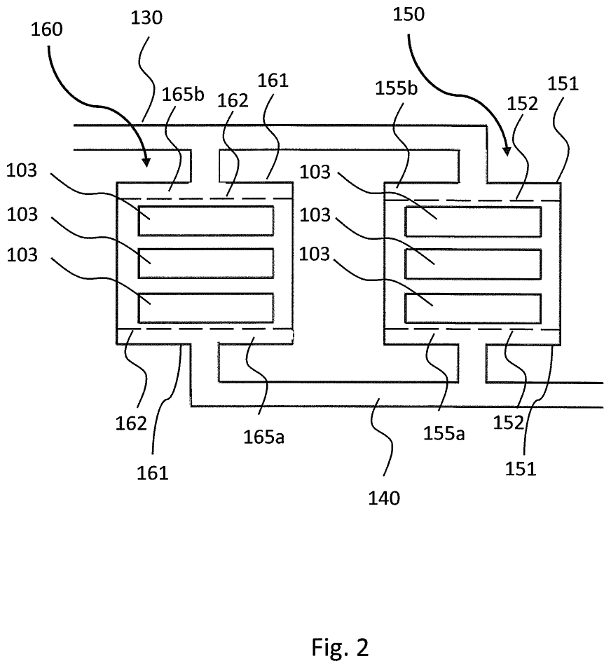

FIG. 2 depicts a plurality of battery modules 150, 160 according to another embodiment. The battery module 150 and the further battery module 160 are fluidically connected via a common cooling fluid inlet 140 and a common cooling fluid outlet 130. Battery cells 103 are disposed in the battery modules 150, 160. Each of the battery modules 150, 160 comprises a housing outer wall 151, 161 and two housing inner walls 152, 162. The housing inner walls 152, 162 of the respective battery modules 150, 160 together with the housing outer wall 152, 161 each form a cooling fluid manifold 155a, 155b, 165a, 165b. Cooling fluid enters the cooling fluid manifold 155b, 165b via the cooling fluid inlet 140. The inner walls of the housing 152, 162 include a plurality of openings that allow the cooling fluid to flow into the region of the battery cells 103 and to flow out of the region of the battery cells 103, respectively. In the further embodiment, the cooling fluid flows in a fluid flow direction within the battery module 150, 160 from the bottom to the top.

In another embodiment, the cooling fluid may flow in a different fluid flow direction. In order to obtain a uniform distribution of the cooling fluid over the battery modules 150, 160 at a constant pressure, the cross-section of the cooling fluid inlet must be larger in a region of the battery module 160 than in a region of the battery module 150.

Since the devices and processes described in detail above are exemplary embodiments, they can be modified to a large extent in the usual way by a person skilled in the art without leaving the field of the invention. In particular, the mechanical arrangements and the proportions of the individual elements to each other are simply exemplary. Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed is:

1. A battery module housing comprising:
a housing interior configured to receive at least one battery cell,
a housing inner wall arranged to spatially separate housing inner space from a housing outer wall of the battery module housing, and
a cooling fluid manifold arranged between the housing inner wall and the housing outer wall, and
wherein the housing inner wall comprises at least one opening configured to facilitate flow of a cooling fluid from the cooling fluid manifold into the housing inner space.

2. The battery module housing according to claim 1, wherein the housing inner wall further comprises a plurality of openings distributed and disposed in the housing inner wall.

3. The battery module housing according to claim 2, wherein a cross-section of the cooling fluid manifold is at least as large as a sum of all cross-sections of the plurality of openings.

4. The battery module housing according to claim 3, wherein the cross-sectional area of the cooling fluid manifold is greater by √2 than the sum of all cross-sectional areas of the plurality of openings.

5. The battery module housing according to claim 1, wherein the at least one opening is arranged in the housing inner wall such that when the cooling fluid flows into the housing inner space, the cooling fluid flows around a battery module element.

6. The battery module housing according to any claim 1, wherein:
a plurality of the battery cells is arranged in the housing interior, and
an opening is associated with at least one battery cell.

7. The battery module housing according to claim 6, wherein the opening is arranged in front of a battery cell that is closest to the opening.

8. The battery module housing according to claim 1, wherein the cooling fluid manifold comprises a cooling fluid inlet configured to facilitate flow of the cooling fluid into the cooling fluid manifold.

9. The battery module housing according to claim 1, wherein the battery module housing further comprises a still further housing inner wall, and between the further housing inner wall and a further housing outer wall, and wherein the further housing inner wall comprises at least one further opening configured and arranged to enable the cooling fluid to flow out of the housing inner region.

10. The battery module housing according to claim 9, wherein the further cooling fluid manifold further comprises a cooling fluid drain configured to enable the cooling fluid to flow out of the further cooling fluid manifold.

11. A battery module, comprising:
a first battery module housing comprising:
a housing inner space configured to accommodate at least one battery cell therein,
a housing inner wall arranged to spatially separate the housing inner space from a housing outer wall of the battery module housing,
a cooling fluid distributor arranged between the housing inner wall and the housing outer wall, and
wherein the housing inner wall comprises at least one opening configured and arranged to enable a cooling fluid to flow from the cooling fluid distributor into the housing inner space;
a second battery module housing comprising fluid manifold; and
wherein the cooling fluid manifold of the first battery module housing is connected to the cooling fluid manifold of the second battery module housing; and
wherein a cross-section of the cooling fluid manifold of the first battery module housing is larger than a cross-section of the cooling fluid manifold of the second battery module housing.

12. The battery module according to claim 11, wherein the cooling fluid manifold of the first battery module housing further comprises a cooling fluid inlet configured and arranged to enable the cooling fluid to flow into the cooling fluid manifold of the first battery module housing.
